(19) United States
(12) Patent Application Publication
(10) Pub. No.: US 2010/0220233 A1
(43) Pub. Date: Sep. 2, 2010

(54) CLOSED CAPTION DATA PROCESSING SYSTEM AND METHOD

(75) Inventor: Janghwan Lee, Westfield, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/095,623

(22) PCT Filed: Dec. 2, 2005
(86) PCT No.: PCT/US2005/043972

§ 371 Date: May 30, 2008

(51) Int. Cl. H04N 7/00; H04N 7/12

(52) U.S. Cl. 348/468; 375/240.25; 348/E07.001; 375/E07.076

(57) ABSTRACT

The disclosed embodiments relate to a system that inserts closed caption information into an analog video signal. An exemplary embodiment of the system includes a first buffer adapted to store a current frame of closed caption data, a second buffer adapted to store a next frame of closed caption data if the first buffer is full, a third buffer adapted to store a frame-after-next-frame of closed caption data if the first and second buffers are full, and an analog video encoder configured to encode closed caption data from the first buffer, the second buffer and the third buffer into an analog video signal.

### FIELD OF THE INVENTION

This invention relates to the field of processing digital and analog television data, including closed caption data embedded in a digital data stream for display in an analog display signal.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

As the television industry prepares for a transition from broadcasting analog signals to broadcasting digital signals, the interrelationship of a number of industry standards presents a challenge to manufacturers of television equipment. One area where this impact is felt is the use of closed caption information. Closed caption data may appear at the bottom of a TV screen to convey dialog or other information about a program to the hearing impaired.

A standard known as the Advanced Television Systems Committee (“ATSC”) 53 requires closed captioning data to be implemented as user data when used in conjunction with MPEG2 video. A related standard is ISO-1318-2, which describes the format of user data in MPEG2 video. Additional standards known as EIA 608 and EIA 708 describe analog and digital closed captioning formats.

It is difficult for television systems to process analog closed captioning data embedded as user data in a digital closed captioning data stream if the stream has more than two bytes per field. Analog closed captioning encoders typically include a 4-byte buffer for the next frame of closed captioning data. This buffer may overflow at data rates higher than two bytes per field. A complicating factor relates to compliance with two additional standards promulgated by the Society of Cable Telecommunications Engineers (“SCTE”). Those standards are known as the SCTE 20 and SCTE 21 standards and they set forth requirements for a film mode. The film mode is implemented for closed caption data in many DVD entertainment programs and the like. An effective way of processing digital closed captioning data, including film mode data, in compliance with these standards is desirable.

### SUMMARY OF THE INVENTION

The disclosed embodiments relate to a system that inserts closed caption information into an analog video signal. An exemplary embodiment of the system includes a first buffer adapted to store a current frame of closed caption data, a second buffer adapted to store a next frame of closed caption data if the first buffer is full, a third buffer adapted to store a frame-after-next-frame of closed caption data if the first and second buffers are full, and an analog video encoder configured to encode closed caption data from the first buffer, the second buffer and the third buffer into an analog video signal.

### BRIEF DESCRIPTION OF THE DRAWINGS

In the drawings:

FIG. 1 is a block diagram of a video system in accordance with an exemplary embodiment of the present invention;

FIG. 2 is a flow diagram of a user data parsing operation in accordance with an exemplary embodiment of the present invention; and

FIG. 3 is a flow diagram of a closed caption data save operation in accordance with an exemplary embodiment of the present invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

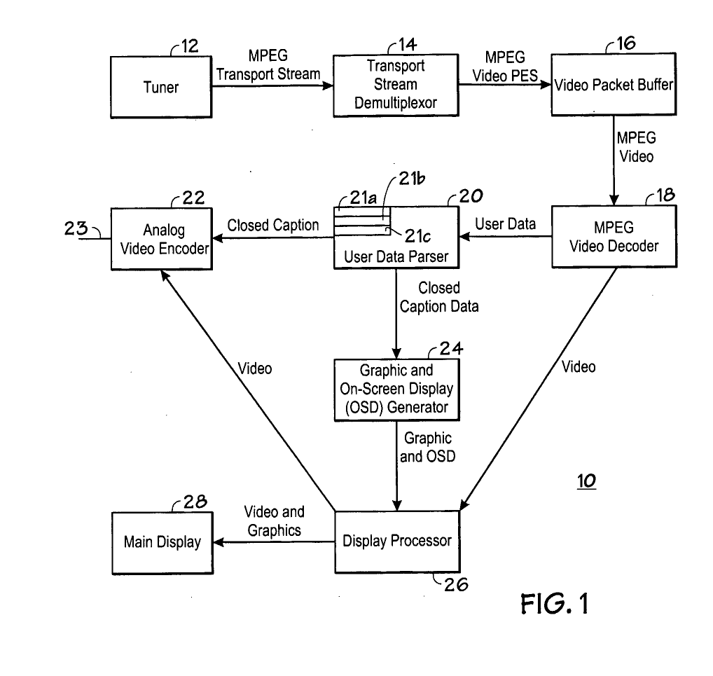

FIG. 1 is a block diagram of an exemplary display system in accordance with the present invention. The diagram is generally represented by the reference number 10. The system 10 may comprise a television set that employs a plasma display, a digital light processing (“DLP”) display, a liquid crystal on silicon (“LCOS”) or the like. The system 10 may be adapted to display both analog and digital programs, including high definition television (“HDTV”) programs.

The system 10 includes a tuner 12, which is adapted to receive television signals such as Advanced Television Systems Committee (“ATSC”) over-air signals or the like. The system 10 is adapted to decode closed captioning data from a digital input and insert corresponding closed caption data in an analog video output. The tuner 12 produces an MPEG transport stream, which is delivered to a transport stream demultiplexor 14. The transport stream demultiplexor 14 demutiplexes the MPEG transport stream into video, audio and other data as a packet element stream (“PES”). The PES data from the transport stream demultiplexor 14 is delivered to a video packet buffer 16. The video and closed caption data may be decoded from the data stored in the video packet buffer 16.

The video packet buffer 16 delivers MPEG video to an MPEG video decoder 18. The MPEG video decoder 18 separates the data received from the video packet buffer 16 into video data and user data. The user data is delivered to a user data parser 20 and the video data is delivered to a display processor 26, as illustrated in FIG. 1. The user data parser 20 extracts closed caption data and may reorder the display data, as well.

In the exemplary embodiment illustrated in FIG. 1, the user data parser 20 includes three buffers 21a, 21b and 21c for storing closed caption data, as explained in detail below. The buffers 21a, 21b and 21c may be adapted to store, respectively, a current frame of closed caption data, a next frame of closed caption data and a frame-after-next-frame of closed caption data. Under certain conditions, such as film mode support, a buffer that stores closed caption data for a frame after the next is desirable because it may be used to iterate the same data in two consecutive frames in the same fields.

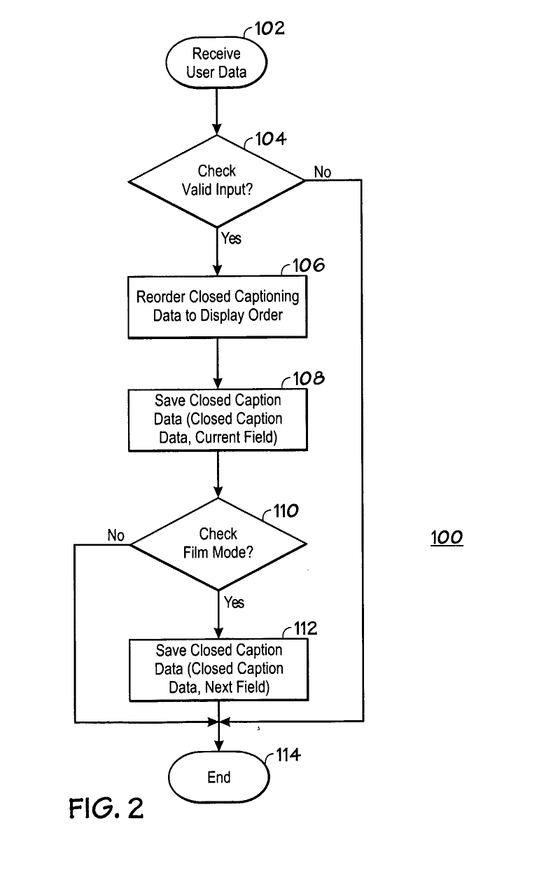

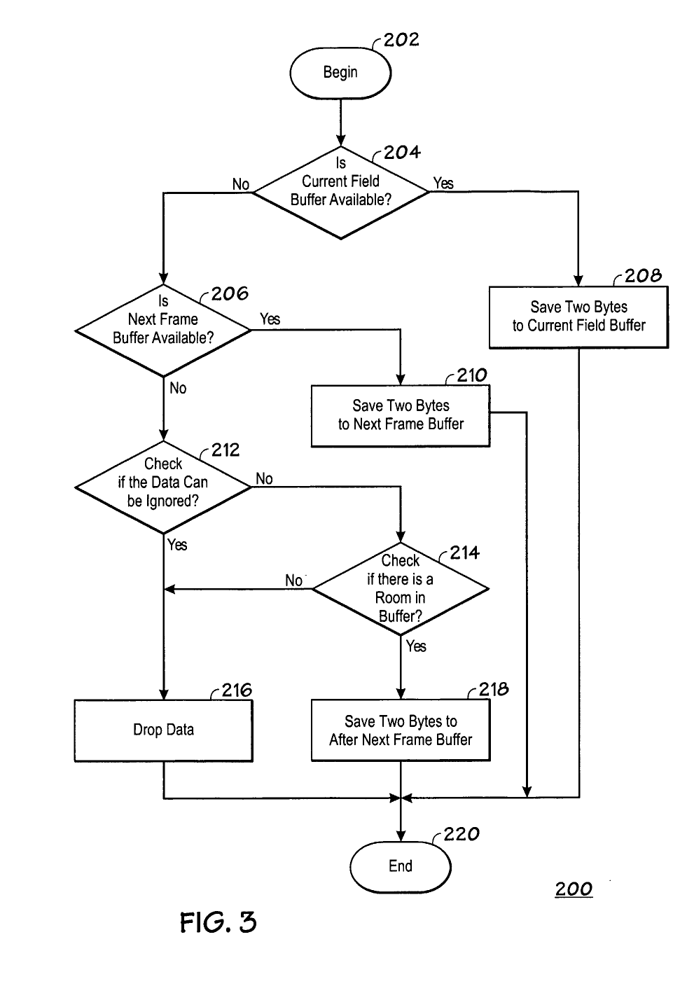

In alternative embodiments of the present invention, closed caption data buffers such as the buffers 21a, 21b and 21c may be disposed in other components within the system 10, such as the MPEG video decoder 18 or an analog video decoder 22. An exemplary decision making process governing the storing of closed caption data in the buffers 21a, 21b and 21c is explained in detail below with reference to FIG. 2 and FIG. 3.

Closed caption data is delivered by the user data parser 20 to the analog video encoder 22. The closed caption data is also provided by the user data parser 20 to a graphic and on-screen display (“OSD”) generator 24. The analog video encoder 22 encodes the closed captioning data received from the user data parser 20 with video and provides an analog video output 23.

The graphic and OSD generator 24 delivers graphic and OSD data to the display processor 26, where it is combined with the video data received from the MPEG video decoder 18. The display processor 26 then delivers digital video and graphics data to a main display 28.

Video is also delivered by the display processor 26 to the analog video encoder 22. This video information is converted to analog form and combined with closed caption data received from the user data parser 20 by the analog video encoder 22. The analog video output generated by the analog video encoder 22 may be compatible with NTSC or PAL formats. The closed caption data may be presented as vertical blanking interval (“VBI”) data by the analog video encoder 22.

The format for closed captioning data and user data is defined in standards such as the ATSC 53 standard, the EIA708 standard and the EIA608 standard. In an exemplary embodiment of the present invention, EIA608 closed caption data is delivered to the analog video encoder 22 to be inserted as closed captioning data. The analog video encoder 22 may be adapted to provide two bytes of buffer per field for closed captioning data. Four bytes of closed captioning data per frame may be used for interlaced video. More than four bytes of closed captioning data may be present for some special cases like film mode operation or to provide a special stream that has more than one picture header user data per field.

FIG. 2 is a flow diagram of a user data parsing operation in accordance with an exemplary embodiment of the present invention. The process is generally referred to by the reference numeral 100. As shown at block 102, the process begins with the receipt of user data by the user data parser 20 (FIG. 1). At decision block 104, the received user data is checked for validity. If the user data is not valid, the process ends, as illustrated at block 114. If the user data is valid at the decision block 104, closed captioning data embodied in the received data is reordered to correspond to the correct display order, as shown at block 106. At block 108, the closed caption data is saved for a current field. The current field data may be stored in a buffer intended to save current field data, such as the buffer 21a in the user data parser 20 (FIG. 1).

At block 110, the closed caption data is checked for correspondence to a film mode. If the data does not correspond to film mode data, the process ends at block 114. If, as a result of the check for film mode at block 110, the data is determined to correspond to film mode data, the data is saved as corresponding to a next field, as shown at block 112. This data may be saved in a buffer intended to save closed caption data for a next frame, such as the buffer 21b in the user data parser 20 (FIG. 1). After the next field is saved, the process ends, as illustrated at block 114.

FIG. 3 is a flow diagram of a closed caption data save operation in accordance with an exemplary embodiment of the present invention. The process is generally referred to by the reference number 200. At blocks 108 and 112 in FIG. 2, closed caption data is saved relative to a current frame and a next frame.

Exemplary embodiments of the process shown in FIG. 3 may be implemented in programmed subroutines that may be called by a computer program to save closed caption data. In an exemplary embodiment of the present invention, a subroutine represented by FIG. 3 may have two input parameters: closed caption data and field information. The field information may be indicative of whether the corresponding closed caption data corresponds to a current field or a next field.

At block 202 the process begins. At a decision block 204, a decision is made as to whether a current field buffer (for example, the buffer 21a in FIG. 2) is available. If the current field buffer is available, two bytes of closed caption data are stored to the current field buffer, as illustrated at block 208. Thereafter, the process ends, as illustrated at block 220.

If the current field buffer is not available at the decision block 204, a determination is made as to whether a next frame buffer (for example, the buffer 21b in FIG. 2) is available at block 206. If the next frame buffer is available, two bytes of closed caption data are stored to the next frame buffer, as illustrated at block 210. Thereafter, the process ends, as illustrated at block 220.

If the next frame buffer is not available at the decision block 206, a check is made regarding whether the data can be ignored at block 212. If the data can be ignored, the data is dropped as illustrated at block 216. Thereafter, the process ends, as illustrated at block 220.

If it is determined that the data cannot be ignored at the decision block 212, a frame-after-next-frame buffer (for example, the buffer 21c in FIG. 2) is checked for room, as shown at a decision block 214. If there is no room in the frame-after-next-frame buffer, the data is dropped, as illustrated at block 216. Thereafter, the process ends as illustrated at block 220.

If there is room in the frame-after-next-frame buffer for the data at the decision block 214, two bytes of closed caption data are stored to the frame-after-next-frame buffer and identified as corresponding to a frame after the next frame. Thereafter, the process ends, as illustrated at block 220.

To summarize the process illustrated in FIG. 3, when closed caption data is received, a current field buffer 21a (FIG. 1) is checked for room. The data will be saved if there is room in the current field buffer 21a. If the current field buffer 21a is full, a check is made as to whether a next frame buffer 21b (FIG. 1) is already occupied as well. If the next frame buffer 21b is also occupied, the closed caption data will be stored in a buffer 21c corresponding to after the next frame.

The process permits checking whether the data may be ignored prior to checking the next frame buffer again. Data may be ignored if, for example, it represents parity data only. If the data is parity only, an analog closed caption decoder, which may be connected to an analog video output from the analog video encoder 22 (FIG. 1), may ignore the data. This condition may be observed between receipt of blocks of meaningful data. The discarding of information such as parity information reduces memory consumption in cases of high data rate transfer of closed caption information. In addition, data may be dropped if a buffer would otherwise be overflowed.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system, comprising:
a first buffer adapted to store a current frame of closed caption data if the first buffer is not full;
a second buffer adapted to store a next frame of closed caption data if the first buffer is full;
a third buffer adapted to store a frame-after-next-frame of closed caption data if the first buffer and the second buffer are full; and
an analog video encoder adapted to encode closed caption data from the first buffer, the second buffer and the third buffer into an analog video signal.

2. The system recited in claim 1, wherein the current frame of closed caption data, the next frame of closed caption data and the frame-after-next-frame of closed caption data are derived from an MPEG2 video stream.

3. The system recited in claim 1, wherein the closed caption data encoded into the analog video stream complies with an EIA 608 standard.

4. The system recited in claim 1, wherein the first buffer, second buffer and third buffer are located in a user data parser that is adapted to deliver the current frame of closed caption data, the next frame of closed caption data and the frame-after-next-frame of closed caption data to the analog video encoder.

5. The system recited in claim 4, wherein the user data parser is adapted to determine if closed caption data may be ignored if the first buffer and the second buffer are full.

6. The system recited in claim 5, wherein the closed caption data is ignored if the closed caption data comprises parity data.

7. The system recited in claim 1, wherein the analog video encoder is adapted to combine video data received from a display processor with the current frame of closed caption data, the next frame of closed caption data and the frame-after-next-frame of closed caption data to produce the analog video signal.

8. The system recited in claim 1, wherein the current frame of closed caption data, the next frame of closed caption data and the frame-after-next-frame of closed caption data each comprise two bytes of data.

9. A method of processing closed caption data, comprising:
receiving a frame of closed caption data;
storing the frame of closed caption data as a current frame of closed caption data in a first buffer if the first buffer is not full;
storing the frame of closed caption data as a next frame of closed caption data in a second buffer if the first buffer is full;
storing the frame of closed caption data as a frame-after-next-frame of closed caption data in a third buffer if the first buffer and the second buffer are full; and
encoding closed caption data from the first buffer, the second buffer and the third buffer into an analog video signal.

10. The method recited in claim 9, comprising deriving the frame of closed caption data from an MPEG2 video stream.

11. The method recited in claim 9, wherein the act of encoding the closed caption data comprises formatting the closed caption data according to an EIA 608 standard.

12. The method recited in claim 9, comprising determining if the closed caption data may be ignored if the first buffer and the second buffer are full.

13. The method recited in claim 12, comprising ignoring the closed caption data if the closed caption data comprises parity data.

14. The method recited in claim 9, comprising combining video data with the current frame of closed caption data, the next frame of closed caption data and the frame-after-next-frame of closed caption data to produce the analog video signal.

15. The method recited in claim 9, wherein the recited acts are performed in the recited order.

16. A television system, comprising:
a tuner that is adapted to receive a communication signal and create an MPEG transport stream based on the communication signal;
a transport stream demultiplexor that is adapted to receive the MPEG transport stream and create a packet element stream based on the MPEG transport stream;
a video packet buffer that is adapted to receive the packet element stream and create an MPEG video output based on the packet element stream;
an MPEG video decoder that is adapted to receive the MPEG video output and create a video data stream and a user data stream based on the MPEG video output;
a user data parser that is adapted to receive the user data stream, the user data parser including a first buffer adapted to store a current frame of closed caption data from the user data stream if the first buffer is not full, a second buffer adapted to store a next frame of closed caption data from the user data stream if the first buffer is full, and a third buffer adapted to store a frame-after-next-frame of closed caption data from the user data stream if the first buffer and the second buffer are full;
a display processor that is adapted to receive the MPEG video stream and provide a video output based on the MPEG video stream; and
an analog video encoder adapted to receive the video output from the display processor and to encode the video output with closed caption data from the first buffer, the second buffer and the third buffer into an analog video signal.

17. The television system recited in claim 16, wherein the closed caption data encoded into the analog video stream complies with an EIA 608 standard.

18. The television system recited in claim 17, wherein the user data parser is adapted to determine if closed caption data may be ignored if the first buffer and the second buffer are full.

19. The television system recited in claim 18, wherein the closed caption data is ignored if the closed caption data comprises parity data.

20. The television system recited in claim 16, wherein the current frame of closed caption data, the next frame of closed caption data and the frame-after-next-frame of closed caption data each comprise two bytes of data.
